(19) United States
(12) Patent Application Publication
(10) Pub. No.: US 2012/0204186 A1
(43) Pub. Date: Aug. 9, 2012

(54) PROCESSOR RESOURCE CAPACITY MANAGEMENT IN AN INFORMATION HANDLING SYSTEM

(75) Inventors: Grover Cleveland Davidson, II, Austin, TX (US); Dirk Michel, Austin, TX (US); Bret Ronald Olszewski, Austin, TX (US); Marcos A. Villarreal, Austin, TX (US)

(73) Assignee: INTERNATIONAL BUSINESS MACHINES CORPORATION, Armonk, NY (US)

(21) Appl. No.: 13/023,550

(22) Filed: Feb. 9, 2011

(51) Int. Cl. G06F 9/50

(52) U.S. Cl. 718/104

(57) ABSTRACT

An operating system or virtual machine of an information handling system (IHS) initializes a resource manager to provide processor resource utilization management during workload or application execution. The resource manager captures short term interval (STI) and long term interval (LTI) processor resource utilization data and stores that utilization data within an information store of the virtual machine. If a capacity on demand mechanism is enabled, the resource manager modifies a reserved capacity value. The resource manager selects previous STI and LTI values for comparison with current resource utilization and may apply a safety margin to generate a reserved capacity or target resource utilization value for the next short term interval (STI). The hypervisor may modify existing virtual processor allocation to match the target resource utilization.

### BACKGROUND

The disclosures herein relate generally to information handling systems (IHSs), and more specifically, to the management of processor resource allocation in an IHS.

Information handling systems (IHSs) typically employ operating systems that execute applications or other processes that may require the resources of multiple processors or processor cores. IHSs may employ virtual machine (VM) technology to provide application execution capability during development, debugging, or real time program operations. In a multiple processor environment, a virtual machine VM may virtualize physical processor resources into virtual processors. The VM may employ virtual processors that process application or program code, such as instructions or software threads.

The VM or virtual operating system of an IHS may employ time slicing or time sharing software for use in physical processor resource and virtual processor management during application execution. An application that executes within an IHS provides a workload to that IHS. The VM generates physical processor resource capacity information for each particular workload. The VM assigns virtual processing elements to such a workload during particular time intervals of the executing application. Effective processor resource management tools may significantly improve application execution efficiency in an IHS.

### BRIEF SUMMARY

In one embodiment, a method of managing processor resources in an information handling system (IHS) is disclosed. The method includes loading a virtual machine in the IHS, the virtual machine including a plurality of virtual processors. The method also includes executing, by a processor of the plurality of virtual processors, a workload. The method further includes storing, by a resource manager, short term interval (STI) information that includes processor resource usage over at least one first predetermined time interval. The method still further includes storing, by the resource manager, long term interval (LTI) information that includes processor resource usage over at least one second predetermined time interval that is longer than the at least one first predetermined time interval. The method also includes determining, by the resource manager, a reserved processor resource capacity that corresponds to a capacity related to the LTI information. The method further includes selecting, by the resource manager, STI information of at least one first predetermined time interval as previous short term interval (PSTI) information. The method further includes selecting, by the resource manager, LTI information of at least one second predetermined time interval as previous long term interval (PLTI) information. The method still further includes determining, by the resource manager, a minimum processor resource capacity by selecting the larger of the PSTI information and the PLTI information as the minimum processor resource capacity.

In another embodiment, an information handling system (IHS) is disclosed that includes a plurality of physical processors that include processor resources. The IHS also includes a memory, coupled to the plurality of physical processors, the memory including a virtual machine that includes a plurality of virtual processors that execute a workload. The memory also includes a resource manager that is configured to store short term interval (STI) information that includes processor resource usage over at least one first predetermined time interval. The resource manager is also configured to store long term interval (LTI) information that includes processor resource usage over at least one second predetermined time interval that is longer than the at least one first predetermined time interval. The resource manager is further configured to determine a reserved processor resource capacity that corresponds to a capacity related to the LTI information. The resource manager is still further configured to select STI information of at least one first predetermined time interval as previous short term interval (PSTI) information. The resource manager is also configured to select LTI information of at least one second predetermined time interval as previous long term interval (PLTI) information. The resource manager is further configured to determine a minimum processor resource capacity by selecting the larger of the PSTI information and the PLTI information as the minimum processor resource capacity.

In yet another embodiment, a resource manager computer program product is disclosed that includes a computer readable storage medium for use on an information handling system (IHS) that is configured with an operating system that executes a workload, the IHS including a plurality of physical processors that include processor resources. The computer program product includes first instructions that store short term interval (STI) information that includes processor resource usage over at least one first predetermined time interval. The computer program product also includes second instructions that store long term interval (LTI) information that includes processor resource usage over at least one second predetermined time interval that is longer than the at least one first predetermined time interval. The computer program product further includes third instructions that determine a reserved processor resource capacity that corresponds to a capacity related to the LTI information. The computer program product still further includes fourth instructions that select STI information of at least one first predetermined time interval as previous short term interval (PSTI) information. The computer program product also includes fifth instructions that select LTI information of at least one second predetermined time interval as previous long term interval (PLTI) information. The computer program product further includes sixth instructions that determine a minimum processor resource capacity by selecting the larger of the PSTI information and the PLTI information as the minimum processor resource capacity. The first, second, third, fourth, fifth and sixth instructions are stored on the computer readable storage medium.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a block diagram of a representative information handling system (IHS) that employs the disclosed resource management methodology.

FIG. 2 shows a virtual machine within an IHS that employs the disclosed resource management methodology.

FIG. 3 shows an information store that a virtual machine within an IHS employs to practice the disclosed resource management methodology.

FIG. 4 depicts a flowchart of an embodiment of the disclosed resource management method that provides IHS processor resource information.

FIG. 5 depicts a flowchart of an embodiment of the disclosed resource management method that provides IHS processor resource management capability.

### DETAILED DESCRIPTION

Information handling systems (IHSs) typically employ operating systems that execute applications or other workloads within the IHS. The IHS may include multiple processors, such as processor cores, or other processor elements for application execution and other tasks. The IHS may execute applications or other workloads within a virtual environment, such as a Java virtual machine (JVM) or other virtual machine (VM) environment. (Java is a trademark of Oracle Corporation.) A VM is a software implementation of a physical or real machine. The VM executes programs in a manner similar to that of a physical machine.

In a multiple and shared processor environment, operating system (OS) software in the IHS may virtualize physical processor resources. A hypervisor or virtual machine VM monitor may generate virtual processors from the physical processor resources of the IHS. Virtual processors may provide processing capability for applications that execute within partitions of the VM. The hypervisor and other software of the VM may manage the allocation of virtual processor resources for IHS workloads during application execution.

In one embodiment, the OS may employ more than one virtual processor but typically no more than the physical processors within the IHS. Virtual processors provide one method for executing applications that require the use of more physical processors than the IHS provides. The virtual processor ratio (VPR) is the number of virtual processors divided by the number of physical processors. In another embodiment, the total number of virtual processors in use by the OS may exceed the total number of physical processors within the IHS.

The hypervisor of the VM may assign time slices of each physical processor and physical processor resource to a partition of the VM during application instruction dispatch. This time slice or time sharing operation provides virtual processor assignment and allocation to physical processors within the IHS. Virtual dispatching provides assignment of virtual processor resources to physical processor resources. A hypervisor may dispatch a virtual processor of a partition within a VM to a physical processor resource of the IHS. In a virtual machine, an IHS may employ Micro-Partitioning technology which as a feature of the PowerVM virtualization platform. (Micro-Partitioning and PowerVM are trademarks of the IBM Corp.) Micro-Partitioning technology provides a way to map virtual processors to physical processors wherein the virtual processors are assigned to the partitions instead of the physical processors. In this manner, a particular partition of a VM may assign application execution capability to a physical processor or multiple physical processors during application execution. In other words, a hypervisor may partition or split the resources of a particular physical processor into multiple virtual processors.

VMs often constrain those threads in a multi-threaded processor that correspond to a particular physical processor or processor core to a particular corresponding partition of the VM. This constraint may provide OSs that operate within VMs with the flexibility to “pack” application threads together on physical processors or processor cores. This constraint also allows the OS to “spread” application threads across multiple physical processors or processor cores to improve single-thread performance within the VM.

For example, processor folding techniques provide application thread packing capability. In this manner, the OS of the VM minimizes or reduces unused processor resources. The OS may then release the unused physical processor resources for use by other partitions and thus other applications within the VM. Processor folding or virtual processor folding is a method that the OS of the VM employs to reduce idle virtual processor use and enhance pooled or shared virtual processor use.

Processor folding provides efficient control of virtual processors within the VM. A VM may assign more virtual processors to a partition than needed during average workload performance. The VM may fold, sleep, or otherwise take one or more virtual processors offline during periods of less than peak workload performance. In this manner, folded virtual processors may be brought back online quickly should the workload performance increase.

Capacity on demand (COD) is another significant VM feature that provides temporary access to additional processors or processor resources during peak workload needs. COD may be a customer purchasable feature from IHS manufacturers, distributors, service organizations or other vendors. COD allows users or other entities of the IHS to activate additional physical processing capability during peak application workloads. Customers may receive an IHS that includes more processing capacity, storage, or other capability than is functional at the time of initial purchase from a vendor. COD may allow the customer the option of increasing the processing capability of the IHS by activating dormant IHS capacity without the need for hardware modification or upgrade. COD provides quick capacity improvements without the need to power down any IHS functions.

Determining processor resource allocation at any time is one particular challenge for effective processor folding. Resource management software within the VM may monitor processor resource utilization during a predetermined “interval” of application execution time. This interval provides resource management software or resource managers with a timeframe for processor resource utilization comparison and tracking during application execution within the VM. The resource manager may monitor processor resource utilization during one interval and provide that amount of processor resource with an additional margin of safety for the next interval. If an executing application breaches the safety margin, the IHS hypervisor may bring additional virtual processes online as available to support the increase in workload and utilization. This method works well for executing applications or application workloads that maintain relatively uniform processor resource utilization from one interval to the next.

However, if a workload or executing application requires a sudden increase or decrease in processor resources, processor folding may not respond in an efficient manner. If the workload increases rapidly, the resource manager may not be able to respond quickly enough and manage capacity demands with an increase in processor resources. In this case, the workload may slow or stall while waiting for more processor resources to become available. The latency for processor resource increase may be unacceptably long in some circumstances.

On the other hand, if the workload decreases rapidly, the resource manager may not be able to reduce processor resources in an efficient manner. In this case, processor resources may sit idle and not be available for use by other executing applications that may benefit from these resources. Idle processor resources may cause an overall inefficiency in IHS operations. In one embodiment, processor resources may equate directly to physical processors or processor cores. A partition may include a particular workload that consumes processor resources. In other embodiments, processor resources may include any other resource that physical processors or IHS processing elements provide.

IHS workloads may execute with non-linear processor resource utilization. For example, executing applications within a virtual environment may include periodic processor resource utilizations that exhibit capacity peaks and valleys. In order to provide for more efficient utilization of processor resources for application workloads, a method is disclosed that provides for multiple processor resource manager interval measurements and periodic capacity generation.

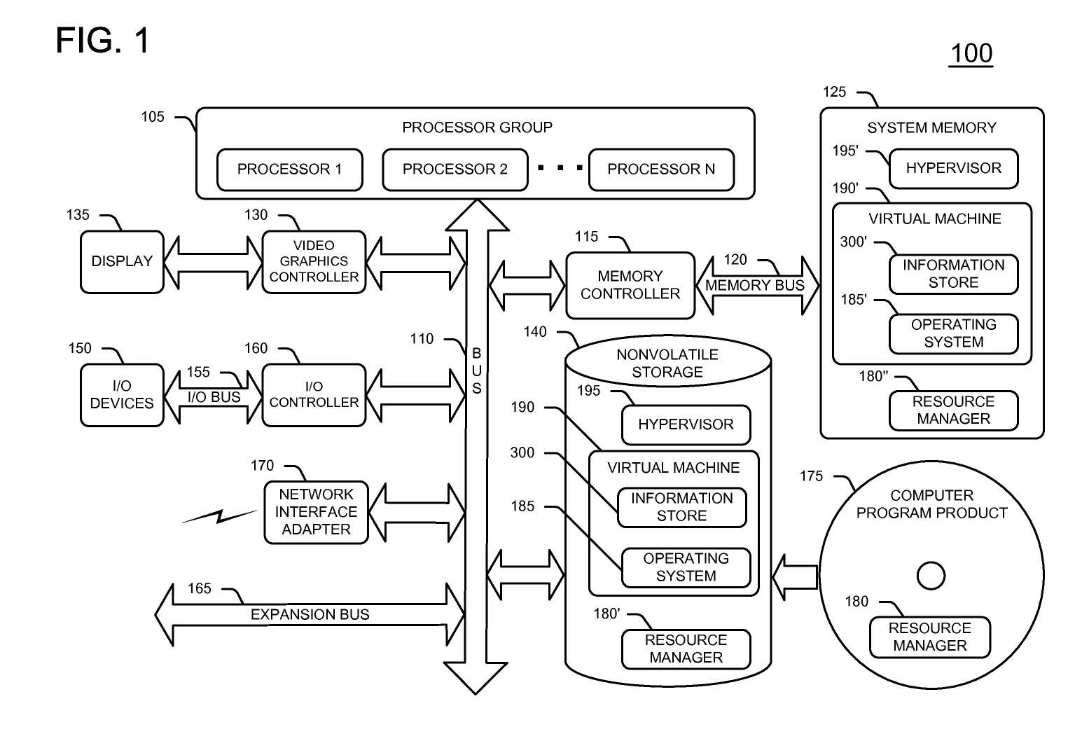

FIG. 1 shows an information handling system (IHS) 100 with a resource manager 180, a virtual machine VM 190, and a hypervisor 195 that employs the disclosed resource management methodology. In one embodiment, VM 190 may include an operating system OS 185 and an information store 300. In one embodiment, VM 190 is a Java virtual machine (JVM). In other embodiments, IHS may employ other types of virtual machines.

IHS 100 includes a processor group 105. In one embodiment, processor group 105 include multiple processors or processor cores, namely processor 1, processor 2, . . . processor N, wherein N is the total number of processors. IHS 100 processes, transfers, communicates, modifies, stores or otherwise handles information in digital form, analog form or other form. IHS 100 includes a bus 110 that couples processor group 105 to system memory 125 via a memory controller 115 and memory bus 120. In one embodiment, system memory 125 is external to processor group 105. System memory 125 may be a static random access memory (SRAM) array or a dynamic random access memory (DRAM) array.

Processor group 105 may also include local memory (not shown) such as L1 and L2 caches (not shown). A video graphics controller 130 couples a display 135 to bus 110. Nonvolatile storage 140, such as a hard disk drive, CD drive, DVD drive, or other nonvolatile storage couples to bus 110 to provide IHS 100 with permanent storage of information. I/O devices 150, such as a keyboard and a mouse pointing device, couple to bus 110 via I/O controller 160 and I/O bus 155.

One or more expansion busses 165, such as USB, IEEE 1394 bus, ATA, SATA, eSATA, PCI, PCIE, DVI, HDMI and other busses, couple to bus 110 to facilitate the connection of peripherals and devices to IHS 100. A network interface adapter 170 couples to bus 110 to enable IHS 100 to connect by wire or wirelessly to a network and other information handling systems. In this embodiment, network interface adapter 170 may also be called a network communication adapter or a network adapter. While FIG. 1 shows one IHS that employs processor group 105, the IHS may take many forms. For example, IHS 100 may take the form of a desktop, server, portable, laptop, notebook, netbook, tablet or other form factor computer or data processing system. IHS 100 may take other form factors such as a gaming device, a personal digital assistant (PDA), a portable telephone device, a communication device or other devices that include a processor and memory.

IHS 100 employs OS 185 that may store information on nonvolatile storage 140. IHS 100 includes a computer program product on digital media 175 such as a CD, DVD or other media. In one embodiment, a designer or other entity configures the computer program product with resource manager 180 to practice the disclosed resource management methodology. In practice, IHS 100 may store resource manager 180 on nonvolatile storage 140 as resource manager 180′. Nonvolatile storage 140 may store hypervisor 195 and VM 190 that includes information store 300 and OS 185. In one embodiment, VM 190 may include resource manager 180.

When IHS 100 initializes, the IHS loads hypervisor 195 and VM 190 that includes information store 300 and OS 185 into system memory 125 for execution as hypervisor 195′, VM 190′, information store 300′ and OS 185′, respectively. System memory 125 may store resource manager 180 as resource manager 180″. In accordance with the disclosed methodology, VM 190 may employ resource manager 180 to manage processor group resources. In one embodiment, IHS 100 may employ VM 190 as a Java virtual machine (JVM) of a virtual machine environment. For example, IHS 100 may employ the Java Development Kit (JDK) or the Java Runtime Environment (JRE) to enable VM technology. Other embodiments may employ other virtual machine environments depending on the particular application.

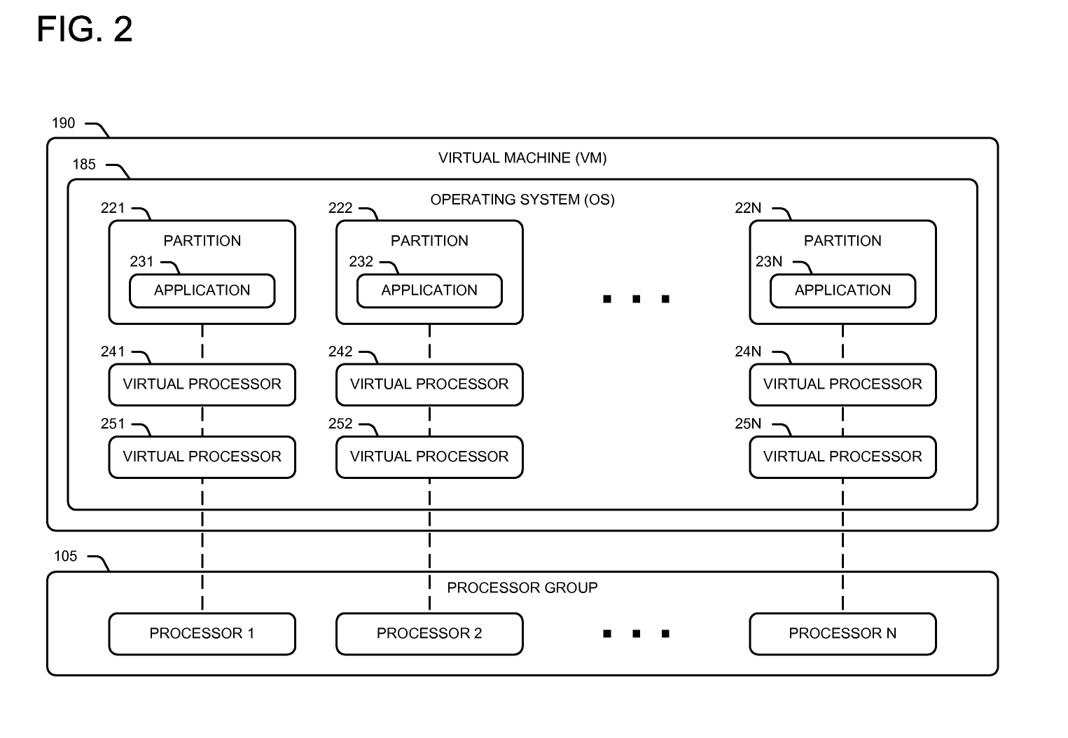

FIG. 2 is a block diagram of VM 190 that includes OS 185. OS 185 may include multiple partitions, namely partition 221, partition 222, . . . partition 22N, wherein N corresponds to the total number of processors of processor group 105 and the corresponding total number of partitions. For example, if processor group 105 includes 8 processors, then N is equal to 8 and corresponds to a total of 8 processors. In a similar fashion, in this example, partition 22N corresponds to the 8^{th} partition within OS 185. Each partition of OS 185 namely, partition 221, partition 222, . . . partition 22N includes an application, namely application 231, application 232, . . . application 23N, respectively. In one embodiment, N corresponds to the total number of applications within the partitions of OS 185. For example, OS 185 may include a total of 8 applications for execution within VM 190.

Hypervisor 195 may generate virtual processors within OS 185. OS 185 may include multiple virtual processors, namely virtual processor 241, virtual processor 242, . . . virtual processor 24N. OS 185 may include more virtual processors, namely virtual processor 251, virtual processor 252, . . . virtual processor 25N. In one embodiment of the disclosed processor resource management method, OS 185 includes a total of 16 virtual processors. VM employs the virtual processors of OS 185 for processing or execution of OS 185 applications, namely application 231, application 232, . . . application 23N, wherein N is the total number of applications.

Hypervisor 195 may assign virtual processor 241 and virtual processor 251 to partition 221. In this manner, OS 185 may employ virtual processor 241 and virtual processor 251 as resources for executing application 231 and executing other applications (not shown) that may execute as part of partition 221. Hypervisor 195 may assign virtual processor 242 and virtual processor 252 to partition 222. In this manner, OS 185 may employ virtual processor 242 and virtual processor 252 as resources for executing application 232 and executing other applications (not shown) that may execute as part of partition 222.

Likewise, hypervisor 195 may assign virtual processor 24N and virtual processor 25N to partition 22N. In this manner, OS 185 may employ virtual processor 24N and virtual processor 25N as resources for executing application 23N and executing other applications (not shown) that may execute as part of partition 22N. If N is the total number of processors of processor group 105, virtual processor 24N and virtual processor 25N are a total of 16 virtual processors within OS 185.

As the dashed lines within FIG. 2 depict, particular physical processors may align or assign to particular partitions and particular virtual processors. In one embodiment, processor 1 of processor group 105 aligns with partition 221, virtual processor 241, and virtual processor 251. Stated in another way, hypervisor 195 may assign virtual processor 241 and virtual processor 251 to the physical processor resources of processor 1. In this manner, partition 1 may assign resource needs such as the workload of application 231 to virtual processor 241 and virtual processor 251. Resource manager 180 may assign or allocate the resource needs of partition 221 to processor 1 of processor group 105.

Processor 2 of processor group 105 aligns with partition 222, virtual processor 242, and virtual processor 252. Hypervisor 195 may assign virtual processor 242 and virtual processor 252 to the physical processor resources of processor 2. In this manner, partition 2 may assign resource needs such as the workload of application 232 to virtual processor 242 and virtual processor 252. Resource manager 180 may assign or allocate the resource needs of partition 222 to processor 2 of processor group 105.

Processor N of processor group 105 aligns with partition 22N, virtual processor 24N, and virtual processor 25N. Hypervisor 195 may assign virtual processor 24N and virtual processor 25N to the physical processor resources of processor N. In this manner, partition N may assign resource needs such as the workload of application 23N to virtual processor 24N and virtual processor 25N. Resource manager 180 may assign or allocate the resource needs of partition 22N to processor N of processor group 105. N represents the total number of processors of processor group 105. In one embodiment wherein N=8, IHS 100 employs 8 physical processors and 16 virtual processors. Many other processor counts, virtual processor assignments, and values of N are possible in other embodiments of the disclosed methodology.

In one embodiment, the virtual processors of VM 190 provide or direct the resources of physical processors of processor group 105. In other embodiments, the virtual processors of VM 190 may employ other processor physical resources, such as physical processor cores, or other compute elements of the processors of processor group 105. In another embodiment of the disclosed processor resource management method, the virtual processors of VM 190 may employ virtual processor cores and provide software thread handling capability for application workloads of VM 190.

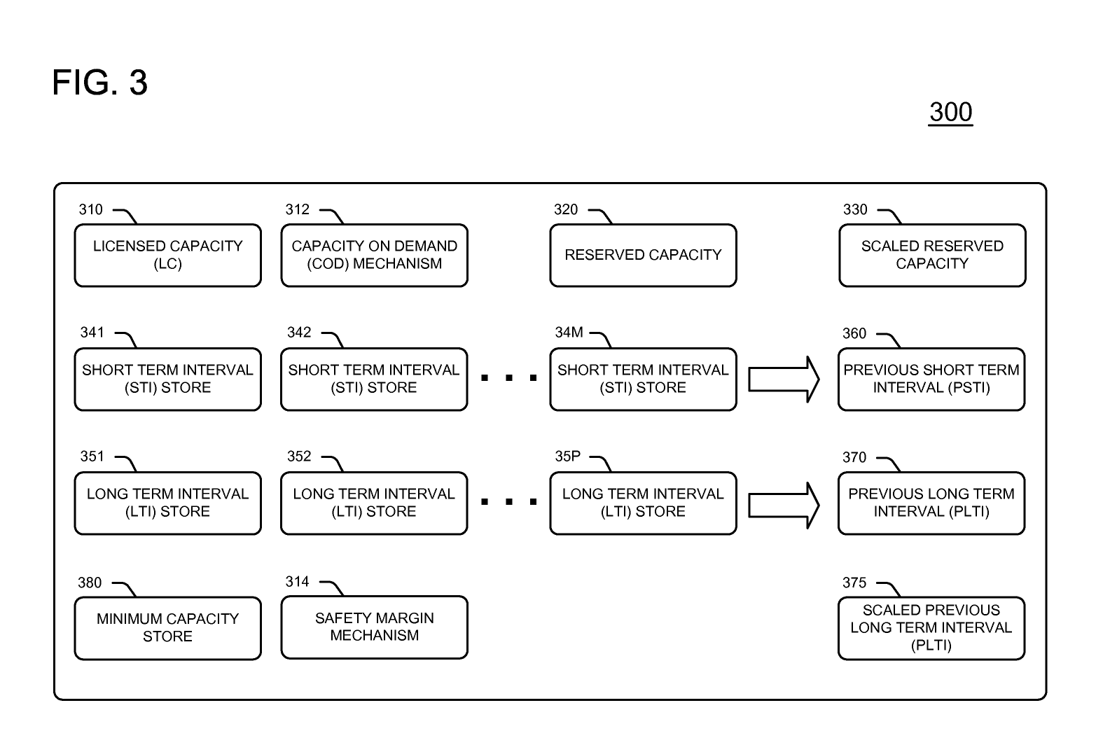

FIG. 3 is a block diagram of the information store 300 that the disclosed processor resource management method may employ. Information store 300 stores information and values that resource manager 180 uses in accordance with the disclosed technology. Information store 300 includes a licensed capacity (LC) store 310 that may store COD license information. The licensed capacity (LC) is the maximum physical processor resource target to which the customer and vendor agree. LC information includes COD license information and other attribute information. The resource manager 180 may employ the licensed capacity information to determine physical processor consumed (PPC) information for a particular IHS.

Information store 300 includes a capacity on demand (COD) mechanism 312. The COD mechanism 312 stores information that determines COD eligibility. Resource manager 180 may employ the COD mechanism 312 to provide processor resource scaling information. Information store 300 includes a safety margin mechanism 314. Safety margin mechanism 314 provides processor resource scaling information. Resource manager 180 may employ the safety margin mechanism 314 to provide an increase or safety margin of processor resources during application execution, such as executing application 231 within partition 221 of VM 190.

Physical processor consumed (PPC) information includes a preference for the number of physical processors that a particular IHS customer and vendor agree as being the target physical processor capacity. If COD is employed, then the PPC information provides a target physical processor capacity, as agreed by customer and vendor. A vendor may actually provide COD capability and physical processor counts greater than or equal to the licensed capacity value in LC store 310. A customer may then use more physical processors than the licensed capacity value within LC 310 in return for agreed upon benefits or payments paid to the vendor. A customer and vendor may agree on new LC 310 values and update or modify the LC store 310 value at any time.

Information store 300 includes a target PPC or reserved capacity store 320. The reserved capacity value within reserved capacity store 320 provides VM 190 with the target goal or initial physical processor count at the start of a particular interval of time. In this manner, the reserved capacity provides a reservation for a target amount of physical processor resources. For example, at the start of a next short term interval (STI), as described in more detail below, the number of physical processors of processor group 105 may align with, or be equal to, the reserved capacity or value within reserved capacity store 320. Because of variations in workload needs within VM 190, resource manager 190 may generate and maintain a scaled reserved capacity 330. In one embodiment, the scaled reserved capacity provides for reduction in reserved capacity or target PPC values when resource manager 180 employs a capacity on demand (COD) mechanism. The COD mechanism may override reserved capacity 320 values with those of the licensed capacity 310 values.

VM 190 may employ resource manager 180 to store one or more short term interval (STI) values in one or more STI stores within information store 300. Information store 300 includes multiple STI stores, namely STI store 341, STI store 342, . . . STI store 34M, wherein M is the total number of STI stores. Resource manager 180 may store STI information, such as the average number of physical processors that VM 190 uses within processor group 105 during a particular short term interval (STI) of time. For example, resource manager 180 may allocate 1 second of processing time within VM 190 as the short term interval (STI). Resource manager 180 stores STI information in a corresponding STI store, such as STI store 341. For example, resource manager 180 may store the STI information corresponding to a particular STI in a respective STI store for that STI. Many other short term intervals (STIs) with values less than or greater than 1 second are possible within other embodiments of the disclosed processor resource management method.

In one embodiment, resource manager 180 stores resource utilization information during each consecutive sampling interval, such as 1 second, to generate M number of STI stores. In another embodiment, resource manager 180 may store specific intervals, such as intervals that correspond to peak utilization of physical processor resources within IHS 100. Resource manager 180 may determine a particular STI store value as particularly important or pertinent to the current state of VM 190. In this case, resource manager 180 may copy a particular pertinent STI store, such as STI store 341, to a previous short term interval (PSTI) store 360, as shown in FIG. 3 with a directed arrow from the grouping of STI stores to previous short term interval (PSTI) store 360. Resource manager 180 may select a particular STI store to copy or move to PSTI store 360 by determining the particular STI store that best corresponds to the current processor resource utilization or the current workload state of VM 190. In this manner, a prediction of processor resource utilization may benefit from historical short term processor resource utilization data.

VM 190 employs resource manager 180 to store one or more long term interval (LTI) values in one or more LTI stores within information store 300. Information store 300 includes multiple LTI stores, namely LTI store 351, LTI store 352, . . . LTI store 35P, wherein P is the total number of LTI stores within information store 300. Resource manager 180 may store LTI information, such as the average number of physical processors within processor group 105 that VM 190 uses during a particular long term interval (LTI) of time. For example, resource manager 180 may allocate 1 hour of processing time within VM 190 as the long term interval. Resource manager 180 stores LTI information in a corresponding LTI store, such as LTI store 351.

For example, resource manager 180 may store the LTI information corresponding to a particular LTI in a respective LTI store for that LTI. Many other long term intervals are possible in other embodiments of the disclosed processor resource management method. In one embodiment, a long term interval corresponds to a time period of longer duration than a short term interval of time. For example, a long term interval (LTI) may be 1 day, 1 week, 1 month, or any other long term time interval. In one embodiment, the long term interval (LTI) exhibits a duration that is substantially longer than a short term interval (LTI). For example, an LTI may be 2, 3 or more orders of magnitude larger than an STI in one embodiment.

In one embodiment, resource manager 180 stores resource utilization information during each consecutive sampling interval, such as 1 hour, to generate P number of LTI stores. In another embodiment, resource manager 180 may store specific intervals, such as LTI intervals that correspond to peak utilization of physical processor resources within IHS 100. Resource manager 180 may determine a particular LTI store value as particularly important or pertinent to the current workload state of VM 190. In this case, resource manager 180 may copy a particular pertinent LTI store, such as LTI store 351, to a previous long term interval (PLTI) 370, as shown in FIG. 3 with a directed arrow from the grouping of LTI stores to a PLTI 370. Resource manager 180 may select an LTI store to copy or move to PLTI 370 by determining the particular LTI store that best corresponds to the current processor resource utilization of the current workload state of VM 190. In this manner, a prediction of processor resource utilization may benefit from long term historical processor resource utilization data.

In one embodiment of the disclosed processor resource management method, resource manager 180 scales the information within PLTI 370 to generate a scaled PLTI 375 that includes a scaled PLTI 375 value. Resource manager 180 may scale the particular value of PLTI 370 in response to the COD capability of VM 190. In one embodiment, the scaled PLTI 375 information provides for reduction in reserved capacity 320 or target PPC values when resource manager 180 employs the COD mechanism 312. The COD mechanism 312 may override reserved capacity 320 values with those of the licensed capacity LC 310 value.

During processor resource management, resource manager 180 may generate minimum capacity or minimum PPC information. Resource manager 180 may store this information within a minimum capacity store 380. Each store within information store 300 maintains processor resource information in one form or another for use by resource manager 180. Resource manager 180 maintains and uses the information store 300 data to generate the best fit of physical processor resource allocations for current and next time intervals during application execution within VM 190.

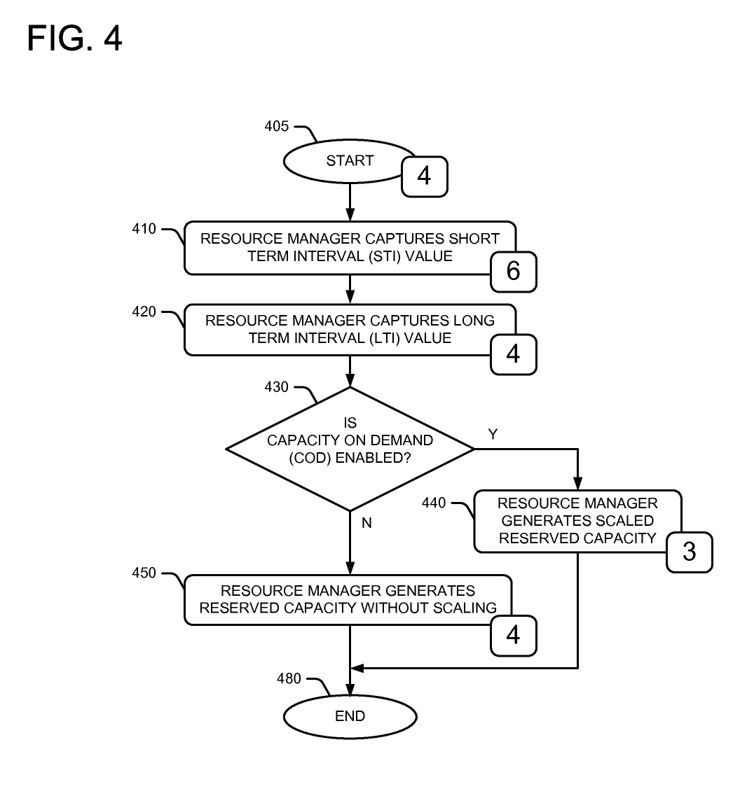

FIG. 4 is a flowchart that shows process flow in an embodiment of the disclosed resource management methodology that provides reserved processor resource capacity management in an IHS. More specifically, the flowchart of FIG. 4 shows how the resource manager 180 that VM 190 employs both generates and continuously updates the reserved processor resource capacity values for workloads of IHS 100.

The disclosed resource management method starts, as per block 405. Resource manager 180 may initiate the resource management method with a previous or predetermined reserved capacity value, such as that of reserved capacity 320. For example, as shown by the number 4 at start block 405, resource manager 180 may provide an initial reserved capacity of 4 physical processors, such as those of processor group 105. In one embodiment, 4 physical processors of processor group 105 correspond to 8 virtual processors, such as those shown in FIG. 2 of VM 190. As described above, hypervisor 195 may assign a particular virtual processor to a portion of a particular physical processor or any other processor resource within IHS 100.

Resource manager 180 captures and stores the short term interval (STI) value, as per block 410. The STI value is the average processor utilization that resource manager 180 stores in an STI store during an STI when an application such as application 231 executes. For example, as shown by the STI value 6 adjacent block 410 in FIG. 4, resource manager 180 may determine that VM 190 uses an average of 6 physical processors of processor group 105 within IHS 100 during a 1 second short term time interval. Many other short term interval timeframes are possible in other embodiments of the disclosed method. Resource manager 180 may store multiple STI values with a respective STI value being stored in each of STI store 341, STI store 342, . . . STI store 34M, as needed, wherein M is the total number of STI stores.

In a manner similar to the capture of STI information in STI stores discussed above, resource manager 180 captures long term interval (LTI) information in LTI stores Resource manager 180 captures an LTI value, as per block 420. The LTI value is the average processor utilization that resource manager 180 stores in an LTI store during an LTI when an application such as application 231 executes. In more detail, during application execution, such as application 231, resource manager 180 stores the average processor utilization during a long term interval(LTI) in a respective LTI store. In one example, as shown by the LTI value 4 adjacent block 420, resource manager 180 may determine that VM 190 uses an average of 4 physical processors of processor group 105 during a 1 hour long term time interval. Resource manager 180 stores this LTI value in a respective LTI store such as LTI store 351.

Since the STI and LTI values are average values of processor resource utilization, fractional numbers are possible within STI and LTI store values, such as in STI store 341 and LTI store 351. Resource manager 180 may store multiple LTI values with a respective LTI value being stored in each of LTI store 351, LTI store 352, . . . LTI store 35P, as needed, wherein P is the total number of LTI stores. In this manner, resource manager 180 may store a history of 1 day, 1 week, 1 month, or any other period of LTI store values. In one embodiment, LTI store values correspond to average physical processor core utilization during a 1 hour time interval. In other embodiments, resource manager 180 may track different processor resources and utilize different LTI time scales.

Resource manager 180 performs a test to determine if capacity on demand (COD) mechanism 312 is enabled, as per block 430. If the COD mechanism 312 is enabled, resource manager 180 employs the LC information of LC 310 to determine if the reserved capacity 320 value requires modification or scaling. Resource manager 180 generates a scaled reserved capacity value for storage in scaled reserved capacity store 330, as per block 440. If COD is enabled, resource manager 180 may modify the reserved capacity information within reserved capacity 320 to reduce the reserved capacity as needed to maintain the reserved capacity at or below the LC value of LC 310. For example, if LC 310 includes a LC value of 3, then as shown at block 440, resource manager 180 scales the reserved capacity 320 down to a value of 3. In this example, resource manager 180 stores a value of 3 within scaled reserved capacity store 330.

Resource manager 180 may use different scaling factors and scaling methods to modify the reserved capacity value in reserved capacity store 320 to generate the scaled reserved capacity value for storage in reserved capacity store 330. If COD is not enabled, resource manager 180 generates the reserved capacity value without scaling, as per block 450. For example, if COD is not enabled, resource manager 180 may ignore LC 310 information and use either the current reserved capacity value in store 320 or the last LTI capture value, such as a value of 4, to store within reserved capacity store 320. Resource manager 180 uses this reserved capacity 320 value at the start of the next STI to determine the next processor resource utilization target.

In one embodiment, as shown in FIG. 4, the STI processor resource utilization may be larger than the reserved capacity. For example, the STI processor resource utilization as shown by the value of 6 at block 410 is larger than the reserved capacity 320 value of 4, as shown at block 450. Although the STI processor utilization may be larger than the LTI processor utilization, the larger STI values may not necessarily affect the reserved capacity 320 values for the next interval.

The disclosed resource management method ends, as per block 480. Resource manager 180 may repeat the steps of FIG. 4 in a continuous manner to capture additional processor resource information and to generate multiple target PPC or reserved capacity 320 data. Resource manager 180 may capture reserved capacity 320 values for each interval of the workload of IHS 100 or application execution, such as that of application 231.

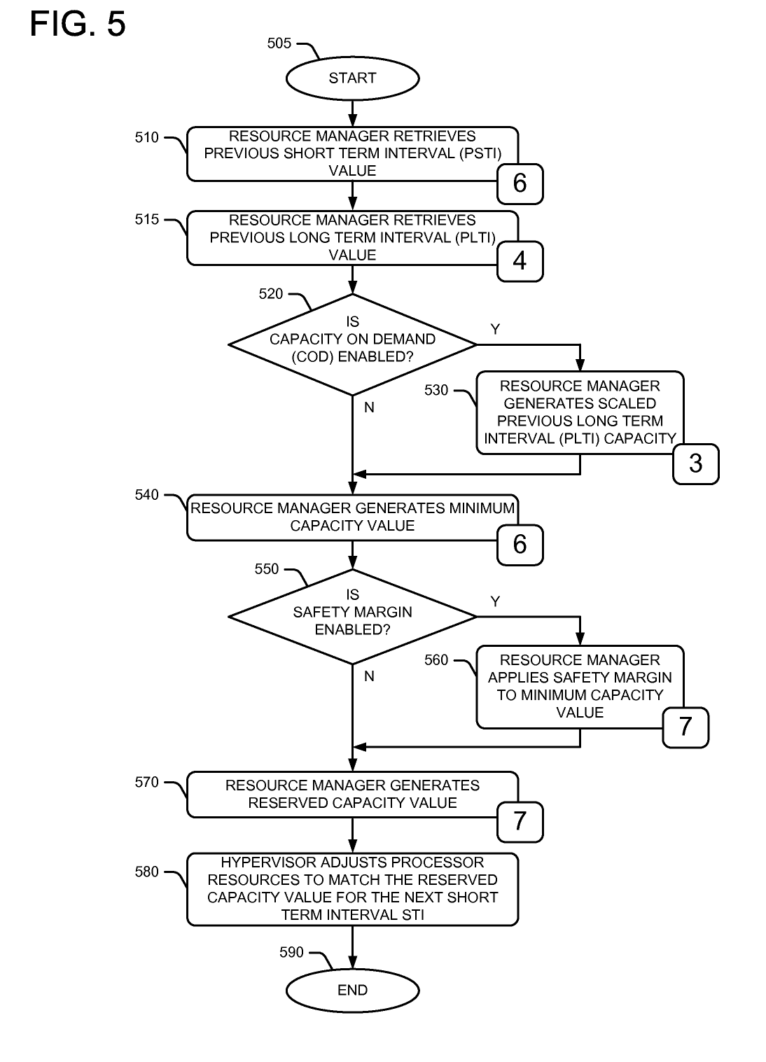

FIG. 5 is a flowchart that shows process flow in an embodiment of the disclosed resource management methodology that provides target PPC or reserved capacity information. More specifically, the flowchart of FIG. 5 shows how resource manager 180 determines the best fit of physical processor resources per specific time intervals of IHS 100 workloads. Hypervisor 195 may use the processor resource information to determine virtual processor allocation to physical processor resources. The disclosed resource management method starts, as per block 505.

Resource manager 180 retrieves previous short term interval PSTI 360 value, as per block 510. In one embodiment, as shown by the number 6 at block 510, PSTI 360 exhibits a value of 6 processors. This PSTI 360 value of 6 indicates that the previous STI used an average processor utilization of 6 processors of processor group 105.

Resource manager 180 may select any previous STI value as the best PSTI 360 value. Resource manager 180 may select from any STI store, namely STI store 341, STI store 342, . . . STI store 34M, wherein M is the total number of STI stores. For use as the best PSTI 360 value, resource manager 180 may select a previous STI that best fits or matches the current workload state. For example, a previous STI may represent a previous workload state during a particular previous time interval. In this example, the previous workload was operating in a similar state of processor resource utilization to that which the workload is currently operating.

Resource manager 180 retrieves a previous long term interval (PLTI) value from PLTI store 370, as per block 515. In one embodiment, as indicates by the value 4 at block 515, PLTI store 370 exhibits a value of 4 processors. In one example, the value 4 in PLTI store 370 indicates that that the previous LTI used 4 processors as the average processor utilization of processor group 105. Resource manager 180 may select any previous LTI store as the best PLTI 370 value.

Resource manager 180 may select from any LTI store, namely LTI store 351, LTI store 352, . . . LTI store 35P, wherein P is the total number of LTI stores. For use as the best PLTI 370 value, resource manager 180 may select the previous LTI that best fits the current workload for any number of measures. For example, a previous LTI may represent a time interval or period during which the current workload was operating in a similar state of processor resource utilization to that which the workload currently operates.

Resource manager 180 performs a test to determine if the capacity on demand (COD) mechanism 312 is enabled, as per block 520. If the COD mechanism 312 is enabled, resource manager 180 employs the LC value of LC store 310 to determine if the PLTI 370 value requires modification or scaling. Resource manager 180 generates a scaled PLTI value for PLTI store 375, as per block 530. If COD is enabled, resource manager 180 modifies the previous long term interval (PLTI) value in PLTI store 370 to form the scaled previous long term interval (PLTI) value in scaled PLTI store 375. For example, resource manager 180 scales the reserved capacity to a value of 3. In this example, resource manager 180 generates and stores a value of 3 within scaled PLTI 375. Resource manager 180 may use different scaling factors and scaling methods to modify the values of PLTI store 370 when generating the values of scaled PLTI store 375.

If COD is not enabled, resource manager 180 populates minimum capacity store 380 with a minimum capacity value in the following manner, as per block 540. For example, if COD is not enabled, resource manager 180 may generate a minimum capacity value that ignores licensed capacity (LC) 310 information and uses the larger of the values in either PSTI store 360 or PLTI store 370 to determine the minimum capacity value for minimum capacity store 380. In one example, if PSTI store 360 exhibits a value of 6 processors, and PLTI store 370 exhibits a value of 4 processors, resource manager 180 stores a value of 6, the larger of the two within minimum capacity store 380.

Resource manager 180 performs a test to determine if the safety margin mechanism 314 is enabled, as per block 550. If the safety margin mechanism 314 is enabled, resource manager 180 applies the safety margin value in safety mechanism 314 to the minimum capacity store 380 value, as per block 560. Resource manager 180 may use any form of scaling or other modification to adjust the value of minimum capacity store 380. For example, as shown in FIG. 5, at block 560, resource manager 180 may increase the value within minimum capacity store 380 to a safety value of 7 processors in response to safety mechanism 314. This may provide an increased or extra capacity of processor resource utilization in case an unexpected workload increase occurs during the next STI.

In one embodiment, the safety margin may be a percentage, such as 120% or any other percentage of increase. In this example, resource manager 180 may increase the minimum capacity store value in minimum capacity store 380 value by 20% to form the reserved capacity 320 value. In another embodiment of the disclosed resource management method, the safety margin may differ for any particular executing application or workload of IHS 100.

If the safety margin capability is not enabled, resource manager 180 does not perform safety margin scaling operations to the minimum capacity value. In that case, resource manager 180 generates the value for reserved capacity 570 by using the minimum capacity value in minimum capacity store 380. However, if the safety margin mechanism 314 is enabled, resource manager 180 modifies the reserved capacity and generates an increased reserved capacity or target PPC value of 7, as shown next to block 570.

In one embodiment, the hypervisor 195 performs virtual processor assignment, such as shown in FIG. 2. Hypervisor 195 performs virtual processor assignment and allocation to IHS 100 physical processors, such as those of processor group 105. Hypervisor 195 adjusts processor resources to match the reserved capacity 320 value for the next STI, as per block 580. In this manner, hypervisor 195 allocates virtual processors to physical processors and may take virtual processors online or offline as needed to satisfy the value within reserved capacity 320.

Hypervisor 195 may adjust virtual processor counts and assignments, such as the virtual processors of VM 190, namely virtual processor 241, virtual processor 242, . . . virtual processor 24N and virtual processor 251, virtual processor 252, . . . virtual processor 25N, wherein N is the total number of physical processors within processor group 105. In one embodiment, hypervisor 195 does not release virtual processors that are taken offline. In other words, hypervisor 195 maintains control of offline virtual processors for potential later use within VM 190.

The disclosed resource management method ends, as per block 590. Resource manager 180 may repeat the steps of FIG. 5 during execution of applications such as application 231 within VM 190 and IHS 100. In this manner, resource manager 180 may continually modify and adjust the processor resource needs of executing applications and the workloads of IHS 100.

IHS 100 may encounter periodic peaks and valleys of processor resource utilization, for example, during end of month processing, or during peak usage of IHS 100 resources. The disclosed method provides for short term interval adjustment of virtual to physical processor resource allocations to manage processor resource utilization swings. Resource manager 180 employs a history of both short and long term interval resource utilization to adjust processor resource allocations in a timely manner.

As will be appreciated by one skilled in the art, aspects of the disclosed resource management methodology may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the FIG. 4 and FIG. 5 flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts of FIG. 4 and FIG. 5 and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowcharts of FIG. 4 and FIG. 5 described above.

The flowcharts of FIG. 4 and FIG. 5 illustrates the architecture, functionality, and operation of possible implementations of systems, methods and computer program products that perform network analysis in accordance with various embodiments of the present invention. In this regard, each block in the flowcharts of FIG. 4 and FIG. 5 may represent a module, segment, or portion of code, which comprises one or more executable instructions for implementing the specified logical function(s). It should also be noted that, in some alternative implementations, the functions noted in the block may occur out of the order noted in FIG. 4 and FIG. 5. For example, two blocks shown in succession may, in fact, be executed substantially concurrently, or the blocks may sometimes be executed in the reverse order, depending upon the functionality involved. It will also be noted that each block of FIG. 4 and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1-8. (canceled)

9. An information handling system (IHS) comprising:
a plurality of physical processors that include processor resources;
a memory, coupled to the plurality of physical processors, the memory including a virtual machine that includes a plurality of virtual processors that execute a workload, the memory including a resource manager that is configured to:
store short term interval (STI) information that includes processor resource usage over at least one first predetermined time interval;
store long term interval (LTI) information that includes processor resource usage over at least one second predetermined time interval that is longer than the at least one first predetermined time interval
determine a reserved processor resource capacity that corresponds to a capacity related to the LTI information;
select STI information of at least one first predetermined time interval as previous short term interval (PSTI) information;
select LTI information of at least one second predetermined time interval as previous long term interval (PLTI) information; and
determine a minimum processor resource capacity by selecting the larger of the PSTI information and the PLTI information as the minimum processor resource capacity.

10. The IHS of claim 9, wherein the physical processor resources are adjusted to match a target physical processor count (PPC) for a next STI.

11. The IHS of claim 10 wherein the resource manager applies a safety margin to the minimum processor resource capacity to generate a target physical processor consumed (PPC) value, the applying of the safety margin being implemented before adjusting the physical processor resources to match the target PPC for the next STI.

12. The IHS of claim 10, wherein the resource manager determines if a capacity on demand (COD) mechanism is enabled, and in response to a finding that the COD mechanism is enabled, the resource manager scales the reserved processor resource capacity to reduce minimum processor resource capacity.

13. The IHS of claim 10, wherein the processor resources include at least one of processors, physical processor cores, virtual processor cores and software threads.

14. The IHS of claim 9, wherein the resource manager provides a different safety margin for each of a plurality of workloads.

15. The IHS of claim 10, wherein the resource manager retains control of unused processor resources that result from adjusting the physical processor resources.

16. A resource manager computer program product, comprising:
a computer readable storage medium for use on an information handling system (IHS) that executes a workload, the IHS including a plurality of physical processors that include processor resources, the memory including an operating system;
first instructions that store short term interval (STI) information that includes processor resource usage over at least one first predetermined time interval;
second instructions that store long term interval (LTI) information that includes processor resource usage over at least one second predetermined time interval that is longer than the at least one first predetermined time interval;
third instructions that determine a reserved processor resource capacity that corresponds to a capacity related to the LTI information;
fourth instructions that select STI information of at least one first predetermined time interval as previous short term interval (PSTI) information;
fifth instructions that select LTI information of at least one second predetermined time interval as previous long term interval (PLTI) information; and
sixth instructions that determine a minimum processor resource capacity by selecting the larger of the PSTI information and the PLTI information as the minimum processor resource capacity;
wherein the first, second, third, fourth, fifth and sixth instructions are stored on the computer readable storage medium.

17. The resource manager computer program product of claim 16, further comprising seventh instructions that adjust the physical processor resources to match a target physical processor count (PPC) for a next STI.

18. The resource manager computer program product of claim 17, further comprising eighth instructions that apply a safety margin to the minimum processor resource capacity to generate a target physical processor consumed (PPC) value, the applying of the safety margin being implemented before the seventh instruction adjust the physical processor resources to match the target PPC for the next STI.

19. The resource manager computer program product of claim 17, further comprising ninth instructions that determine if a capacity on demand (COD) mechanism is enabled, and in response to a finding that the COD mechanism is enabled, the ninth instructions scale the reserved processor resource capacity to reduce minimum processor resource capacity.

20. The resource manager computer program product of claim 16, further comprising tenth instructions that provide a different safety margin for each of a plurality of workloads.
